(19) United States
(12) Patent Application Publication
(10) Pub. No.: US 2021/0301522 A1
(43) Pub. Date: Sep. 30, 2021

(54) RAINPROOF CURTAIN WALL, ASSEMBLY FOR FABRICATING THE SAME, AND WATERPROOF MOISTURE-PERMEABLE ROLL MATERIAL HAVING THE SAME

(71) Applicant: SUZHOU VANTELL MATERIAL TECHNOLOGY CO., LTD., Suzhou (CN)

(72) Inventor: Lei Zhou, Suzhou (CN)

(21) Appl. No.: 16/869,904

(22) Filed: May 8, 2020

(30) Foreign Application Priority Data
Mar. 25, 2020 (CN) 202010218192.9

(51) Int. Cl. E04B 1/62; B32B 3/10; B32B 5/02

(52) U.S. Cl. CPC E04B 1/625; B32B 3/10; B32B 5/028; B32B 5/022; B32B 2607/00; B32B 2307/7265; B32B 2262/02; B32B 2262/101; B32B 5/024

(57) ABSTRACT

The present application discloses a rainproof curtain wall, an assembly for fabricating the same, and a waterproof moisture-permeable roll material having the same. The rainproof curtain wall includes an inner lining layer, a plurality of resilient bumps arrayed on a side of the inner lining layer, and a surface layer provided on a side of the resilient bumps departing from the inner lining layer. The present application can provide good effects of drainage and ventilation, reduce the costs of materials and man power, save the cost of construction and prolong the service life of a building.

### CROSS-REFERENCE TO RELATED APPLICATION

This application claims the priority to Chinese patent application serial no. 202010218192.9, filed on Mar. 25, 2020. The entirety of the above-mentioned patent application is hereby incorporated by reference herein and made a part of this specification.

### FIELD OF THE INVENTION

The invention relates to the field of waterproofness, moisture permeability, drainage and ventilation technologies of a building, and in particular to a rainproof curtain wall, an assembly for fabricating the same, and a waterproof moisture-permeable roll material having the same.

### DESCRIPTION OF RELATED ART

When there is a relatively large difference between the temperatures inside and outside a room, as shown in FIG. 1, large amount moisture or condensed dew will be formed on the outer surface of an assembled building, a square cabin, a wooden building or the like, which will negatively affect the service life of the buildings.

For the purpose of addressing the above issue, as shown in FIG. 2, a breathable pater (that is, a waterproof moisture-permeable house wrap) is usually attached onto the outer surface of a building in the prior art, so that the moisture or condensed dew is produced on the surface of the house wrap.

However, the breathable paper does not have a water draining structure for guiding the flow of the moisture or condensed dew on the surface thereof. Due to the capillary action, the moisture or condensed dew can not be removed from the surface of the breathable paper as soon as possible. Therefore, it is difficult to keep the surface of the breathable paper or the back surface of the outer wall dry, and a mould can be easily produced, shortening the service life of the buildings.

### BRIEF SUMMARY OF THE INVENTION

Regarding the deficiencies present in the prior art, an object of the present application is to provide a rainproof curtain wall having good drainage and ventilation performances, which requires low costs of materials, man power, and construction, and prolongs the service life of a building.

The object of the present application is achieved by the following technical solutions:

A rainproof curtain wall includes an inner lining layer, a plurality of resilient bumps arrayed on one side of the inner lining layer, and a surface layer provided on the side of individual resilient bumps departing from the inner lining layer.

In the above technical solution, the inner lining layer is fixed onto a heat insulation layer of a building, and the surface layer is fixed onto an outer wall hanging board of the building. Therefore, a drainage and ventilation space is formed by the rainproof curtain wall between the heat insulation layer and the outer wall hanging board, in which condensed dews can flow down to prevent moisture from being accumulated on the surface of the heat insulation layer and keep the outer surface of the heat insulation layer dry, serving the functions of drainage and ventilation. In addition, air can flow from bottom to top in the in the drainage and ventilation space to bring the moisture out of the drainage and ventilation space. The resilient bumps provide a gap between the heat insulation layer and the outer wall hanging board, serving as a rainscreen to further improve the effect of drainage and ventilation. As a result, the outer surface of the heat insulation layer and the inner surface of the outer wall hanging board can be kept dry, which avoids the generation of a mould, prolongs the service life of a building, ensures the heat insulation efficiency of the heat insulation layer, saves energy and reduces energy consumption. Meanwhile, providing the surface layer can support and position individual discrete resilient bumps, so as to provide a flat outer surface.

In a preferred embodiment, the inner lining layer may include a first mesh layer, a waterproof moisture-permeable layer or a first waterproof layer, and the surface layer may include a second waterproof layer and/or a second mesh layer.

In the above technical solution, the particular structures of the inner lining layer and the surface layer can be selected based on actual applications of the rainproof curtain wall, so as to meet different demands, providing a wide range of application.

In a preferred embodiment, the resilient bump may be made of ethylene-vinyl acetate (EVA), polypropylene (PP), polyethylene (PE), Polyurethane (PU), foamed EVA, foamed PP, foamed PE, or foamed PU, the waterproof moisture-permeable layer may be made of EVA, PE, polyvinylchloride (PVC), ethylene copolymer bitumen (ECB), PU, PP, or thermo-plastic elastomer (TPE), the first mesh layer and the first waterproof layer may be made of EVA, PE, PVC, ECB, PU, TPE, or glass fibre, and the second waterproof layer and the second mesh layer may be made of EVA, PE, PVC, ECB, PU, TPE or fibre glass.

In the above technical solution, by being made of materials selected from EVA, PP, PE, PU, foamed EVA, foamed PP, foamed PE, or foamed PU, the resilient bumps can meet the requirements for supporting, reducing material cost and remaining resilient. It is to be noted that, any material that can meet the above requirements also in the scope of the present application. In addition, the materials that can meet the requirements for the inner lining layer and the surface layer are in the scope of the present application. Further, by using the resilient bumps made of the above materials, a non-compressible cavity structure is formed between the inner lining layer and the outer lining layer, so as to ensure good performances of drainage and ventilation and provide high supporting strength.

In a preferred embodiment, the resilient bump has a height of 1-20 mm; and the resilient bumps are adhesively fixed with the inner lining layer and the surface layer via hot-melting connection.

In the above technical solution, each of the resilient bumps in an array is separately disposed on the inner lining layer, which requires a low cost. The amount of the resilient bumps per square meter and the height thereof can be adjusted according to the regions having different weathers to which the rainproof curtain wall is applied. Fixing the resilient bumps onto the inner lining layer and the surface layer by hot-melting connection provides a stable fixing at a low cost.

A second object of the present application is to provide an assembly for fabricating the above rainproof curtain wall.

The second object of the present application is achieved by the following technical solution:

an assembly for fabricating a rainproof curtain wall includes a first material rack for providing an inner lining layer, a second material rack for providing a surface layer, and a feeder for providing a resilient bump, in which the feeder is located between the first material rack and the second material rack;

the feeder includes a feeding bin and a hot compression roller which is provided at a discharge port of the feeding bin and to which materials from the first material rack and the second material rack are fed; or

the feeder includes a feeding bin, a hot compression roller provided at a discharge port of the feeding bin, and a compression roller provided under the hot compression roller, with a heating tube provided between the hot compression roller and the compression roller. The material from the first material rack is fed to the compression roller and the material from the second material rack is fed to the hot compression roller and the compression roller.

In the above technical solution, when the inner lining layer is a first mesh layer and the surface layer is a second mesh layer, the inner lining layer provided by the first material rack and the surface layer provided by the second material rack are fed to the hot compression roller, and the resilient bumps provided by the feeding bin fall onto the hot compression roller, where the hot compression roller heats the two ends of the resilient bumps and fixes the resilient bumps between the inner lining layer and the surface layer by pressing, finishing the rainproof curtain wall. In another embodiment, when the inner lining layer is a waterproof moisture-permeable layer and the surface layer is a second mesh layer, the surface layer provided by the second material rack is fed to the hot compression roller, and the resilient bumps fall onto the hot compression roller, where the hot compression roller heats one end of the resilient bumps and fixes the resilient bumps onto the surface layer by pressing. Then, the surface layer fixed with the resilient bumps are fed to the compression roller. During the feeding, the other ends of the resilient bumps are heated by the heating tube, so that the other ends of the resilient bumps become sticky and fixed onto the inner lining layer fed to the compression roller under the compression of the compression roller when the surface layer is fed to the compression roller, finishing the rainproof curtain wall. The whole production line for fabrication is simple and convenient for processing and manufacturing, requiring a low cost of production.

A third object of the present application is to provide a waterproof moisture-permeable roll material having a rainproof curtain wall.

The third object of the present application is achieved by the following technical solution:

a waterproof moisture-permeable roll material includes a rainproof curtain wall, which includes an inner lining layer and a surface layer, the inner lining layer including a waterproof moisture-permeable layer, the surface layer including a second waterproof layer, or the surface layer including a second waterproof layer and a second mesh layer.

In the above technical solution, the waterproof moisture-permeable roll material having a rainproof curtain wall can be applied to the outer surfaces of different buildings, for example, the outer surface of a heat insulation board of a high-rise building, the outer surface of an assembled building, or the outer surface of a wooden house, to form a waterproof and moisture-permeable rainproof curtain wall. For example, the moisture in a heat insulation board (that is, the heat insulation board of a building) is absorbed by the inner lining layer (that is, the waterproof moisture-permeable layer) and condensed to form dews in the inner lining layer. The condensed dews, by overcoming the capillary action, can flow downwards in the drainage and ventilation space, so as to prevent the moisture from being accumulated on the surface of the heat insulation layer and keep it dry, serving the functions of waterproofness, moisture permeability, drainage and ventilation.

In summary, the present application has the following benefit technical effects:

1. by fixing an inner lining layer onto the heat insulation layer of a building and fixing a surface layer onto the outer wall hanging board of the building, a drainage and ventilation space can be formed by the rainproof curtain wall between the heat insulation layer and the outer wall hanging board, so that condensed dews can flow downwards in the drainage and ventilation space, so as to prevent the moisture from being accumulated on the surface of the heat insulation layer and keep it dry, serving the functions of drainage and ventilation. Meanwhile, air flows from bottom to top in the drainage and ventilation space, bringing the moisture out of the drainage and ventilation space. Providing the resilient bumps ensures a gap formed between the heat insulation layer and the outer wall hanging board, which can serve as a rainscreen to improve the effect of drainage and ventilation. Therefore, the outer surface of the heat insulation and the inner surface of the outer wall hanging board can be kept dry, so as to avoid the generation of a mould, prolong the service life of the building, ensure the heat insulation efficiency of the heat insulation layer, save energy and reduce energy consumption. In addition, providing a surface layer enables supporting and positioning individual discrete resilient bumps and providing a flat outer surface;

2. the surface layer can be provided as a sing-layer structure or a double-layer structure, so as to perform a dry or wet plastering operation based on actual needs, facilitating construction;

3. the resilient bumps are adhesively fixed with the inner lining layer and the surface layer by hot-melting connection. During fabrication, when the inner lining layer is the first mesh layer and the surface layer is a second mesh layer, the inner lining layer and the surface layer are fed to the hot compression roller, and the resilient bumps fall onto the hot compression roller, where the hot compression roller heats the two ends of the resilient bumps and fixing the resilient bumps between the inner lining layer and the surface layer by pressing, finishing the rainproof curtain wall. When the inner lining layer is a waterproof moisture-permeable layer and the surface layer is a second mesh layer, the surface layer is fed to the hot compression roller, and the resilient bumps fall onto the hot compression roller, where the hot compression roller heats one end of the resilient bumps and fixes the resilient bumps onto the surface layer by pressing. Then, the surface layer fixed with the resilient bumps are fed to the compression roller. During the feeding, the other ends of the resilient bumps are heated by the heating tube, so that the other ends of the resilient bumps become sticky and fixed onto the inner lining layer fed to the compression roller under the compression of the compression roller when the surface layer is fed to the compression roller, finishing the rainproof curtain wall. In this way, the rainproof curtain wall can be fabricated at a low cost by a simple process.

4. the rainproof curtain wall of the present application can be used as a waterproof moisture-permeable roll material, which can form a waterproof and moisture-permeable rainproof curtain wall structure and be applied onto the outer surface of a building, serving the function of waterproofness, moisture permeability, drainage, and ventilation. It can be also directly applied to a building envelope, for example, the outer surface of a breathable paper of a building, so as to form a rainproof curtain wall, serving the functions of drainage, ventilation and moisture permeability. Further, it can be directly applied to a ventilation structure, for example, a ventilation port of a roof, so as to form a ridge ventilation structure, achieving the ventilation and air circulation in a triangle region formed by the roof of a building. Further, it can be directly applied to a building envelope, for example, on a wall body, a roof, or a floor as a pad layer in place of a wooden stud. In this case, due to its flexibility, facilitates transportation and installation is facilitated, and a flexible supporting structure is formed, providing the effect of drainage and ventilation.

### BRIEF DESCRIPTION OF DRAWINGS

FIG. 1 is the schematic diagram showing the situation in which moisture and condensed dews are formed on the outer surface of a building in the prior art;

FIG. 2 is the schematic diagram showing the situation in which moisture and condensed dews are formed on the surface of a house wrap after adding the house wrap in the prior art;

FIG. 3 is the schematic structural view of Embodiment 1 of the present application;

FIG. 4 is the schematic perspective view of Embodiment 1 of the present application;

FIG. 5 is the schematic structural view of Embodiment 2 of the present application;

FIG. 6 is the schematic perspective view of Embodiment 2 of the present application;

FIG. 7 is the schematic structural view of Embodiment 3 of the present application;

FIG. 8 is the schematic perspective view of Embodiment 3 of the present application;

FIG. 9 is the schematic structural view of Embodiment 4 of the present application;

FIG. 10 is the schematic perspective view of Embodiment 4 of the present application;

FIG. 11 is the schematic perspective view of Embodiment 5 of the present application;

FIG. 12 is the top view of FIG. 11;

FIG. 13 is the schematic explored view of Embodiment 6 of the present application;

FIG. 14 is the schematic perspective view of FIG. 13;

FIG. 15 is the schematic structural view of Embodiment 8 of the present application; and

FIG. 16 is the schematic structural view of Embodiment 9 of the present application.

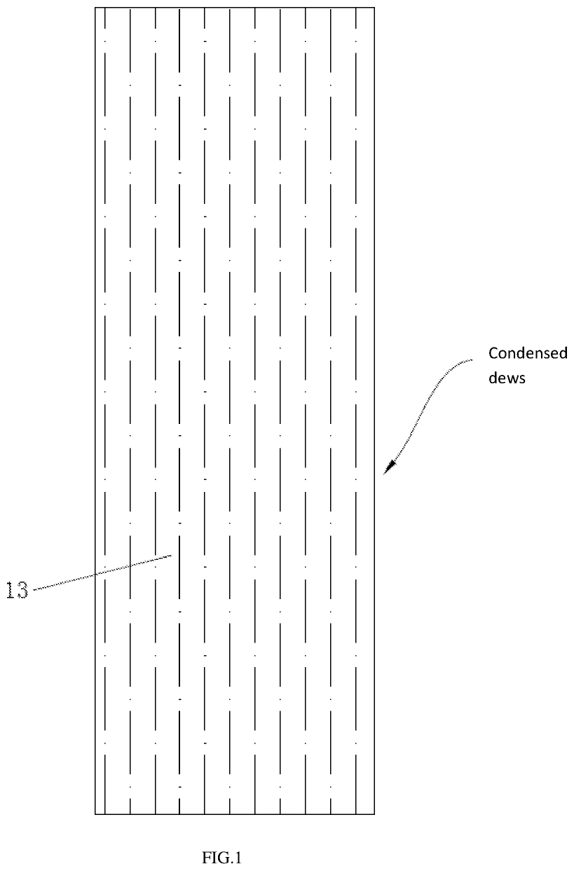

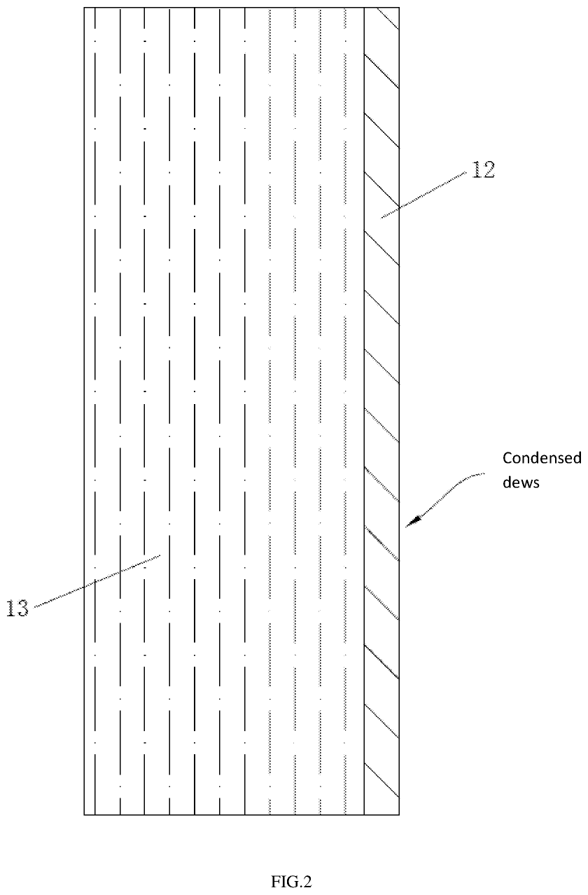

### DETAILED DESCRIPTION

The present application will be further described below in detail in connection with drawings.

### Embodiment 1

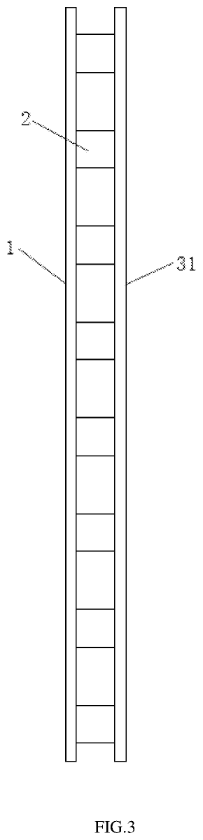

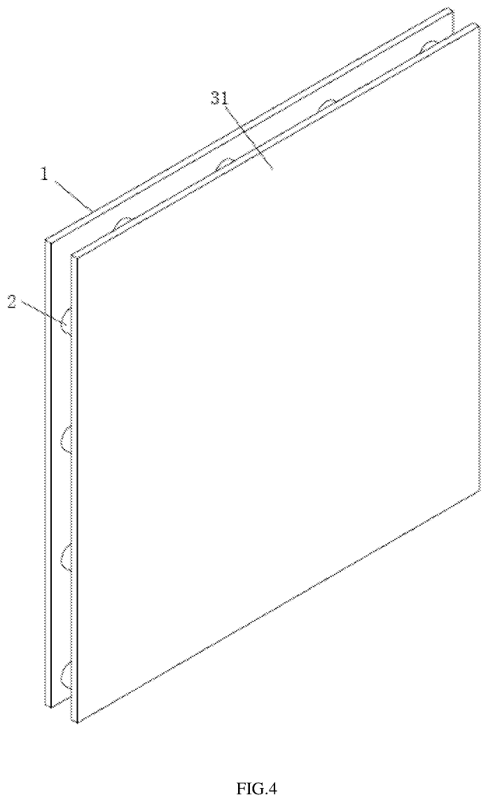

As shown in FIG. 3 and FIG. 4, a rainproof curtain wall comprises an inner lining layer 1, a plurality of resilient bumps 2 arrayed on one side of the inner lining layer 1, and a surface layer 3 provided on the side of individual resilient bumps 2 departing from the inner lining layer 1. Each of the inner lining layer 1, the resilient bump 2, and the surface layer 3 can be made of plastic. A gap is provided between two adjacent resilient bumps 2, individual resilient bumps 2 in the same row or in the same column are equally distanced, and the resilient bumps 2 in two adjacent rows or columns are misaligned with each other. In particular, the inner lining layer 1 is a waterproof moisture-permeable layer made of EVA, PE, PVC, ECB, PU, PP, or TPE; and the surface layer 3 is a second waterproof layer 31 made of EVA, PE, PVC, ECB, PU, TPE or glass fiber. In one embodiment, the second waterproof layer 31 is made of a non-woven fabric. In other embodiments, it can be made of one or more selected from the group consisting of a plastic film, a plastic woven cloth or a glass fibre cloth. The resilient bump 2 can be made of EVA, PP, PE, PU, foamed EVA, foamed PP, foamed PE, or foamed PU. It has a height of 1-20 mm. Each of the resilient bumps 2 in an array is separately disposed on the inner lining layer 1, and thus requires a low cost. In addition, the number of the resilient bumps 2 per square meter and the height thereof can be selected based on the regions having different weathers to which the rainproof curtain wall is applied. In one embodiment, the resilient bump 2 can be of a cylindrical structure, having a diameter of 4-20 mm and a Shore Hardness of 30-70. The resilient bump 2 is adhesively fixed with the inner lining layer 1 and the surface layer 3, for example, by hot-melting connection, which provides a stable fixing in low cost. In particular, the resilient bumps 2 are disposed on the inner lining layer 1 in an amount of 50-2000 per square meter. The particular number of the resilient bumps 2 can be determined according to the performance requirements for the curtain wall.

This embodiment can be applied to a waterproof moisture-permeable roll material. By fixing a waterproof moisture-permeable layer onto the outer surface of a building via a binder or a nail, a waterproof and moisture-permeable rainproof curtain wall structure (that is, a rainscreen) can be formed, which has the functions of waterproofness, moisture permeability, drainage, and ventilation, and facilitates a dry operation and construction.

### Embodiment 2

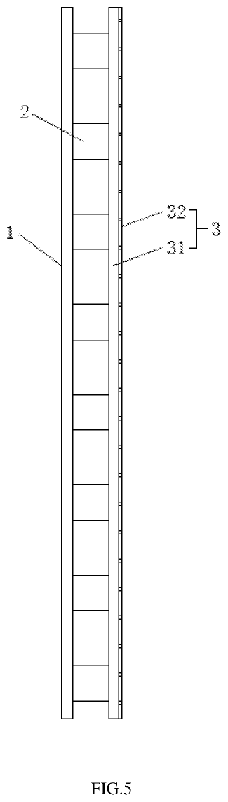

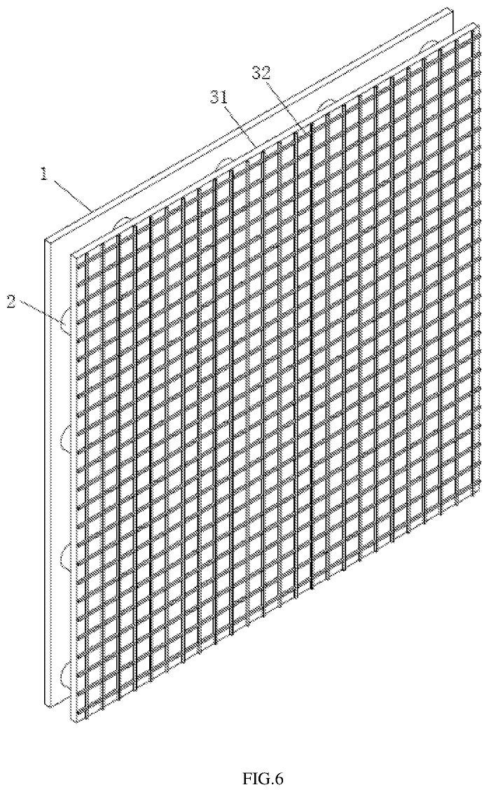

Referring to FIG. 5 and FIG. 6, Embodiment 2 differs from Embodiment 1 in that, the surface layer 3 includes a second waterproof layer 31 and second mesh layer 32. In this embodiment, the second waterproof layer 31 can be a non-woven cloth, the second mesh layer 32 can be a glass fibre mesh cloth, and the second waterproof layer 31 and the second mesh layer 32 can be adhesively fixed with each other.

This embodiment can be applied to a waterproof moisture-permeable roll material. By fixing a waterproof moisture-permeable layer onto the outer surface of a building via a binder or a nail, a waterproof, moisture-permeable, and rainproof curtain wall structure can be formed, which has the functions of waterproofness, moisture permeability, drainage, and ventilation. Providing the second mesh layer 32 facilitates a wet plastering operation and construction.

### Embodiment 3

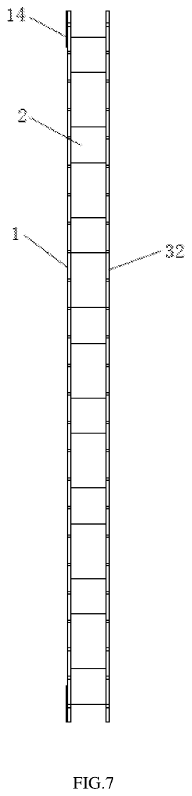

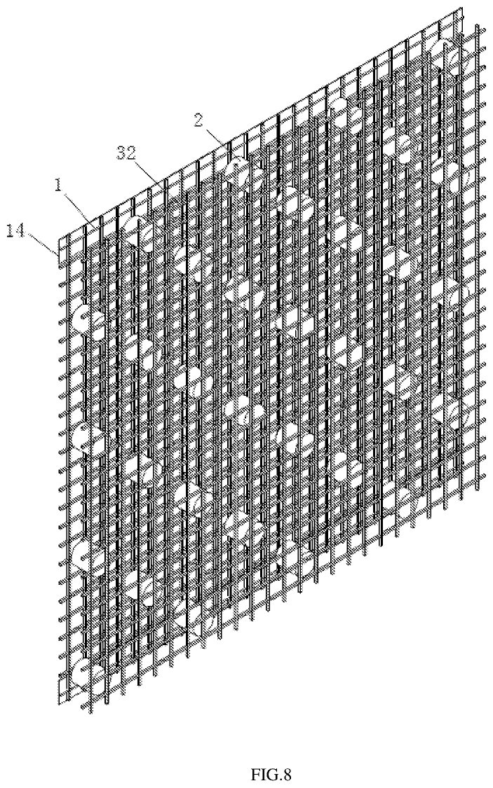

Referring to FIG. 7 and FIG. 8, this embodiment differs from Embodiment 1 in that, the inner lining layer 1 is a first mesh layer, which can be made of EVA, PE, PVC, ECB, PU, TPE, or glass fibre. In this embodiment, the first mesh layer is a glass fibre mesh cloth. The surface layer 3 is a second mesh layer, which is a glass fibre mesh cloth. Both of the first mesh layer and the second mesh layer 32 are a glass fibre mesh cloth, which will not interference the flowing of moisture or condensed dews, ensuring a good dehumidification.

This embodiment can be applied to a building envelope, for example, the outer surface of a breathable paper provided on the outer surface of a building. By adhesively fixing the first mesh layer onto the outer surface of a breathable paper 12, a rainproof curtain wall can be formed, serving the functions of drainage, ventilation, and moisture permeability and facilitating a dry operation and construction. In this embodiment, a self adhesive tape 14 is provided on the side of the first mesh layer facing the breathable paper 12.

### Embodiment 14

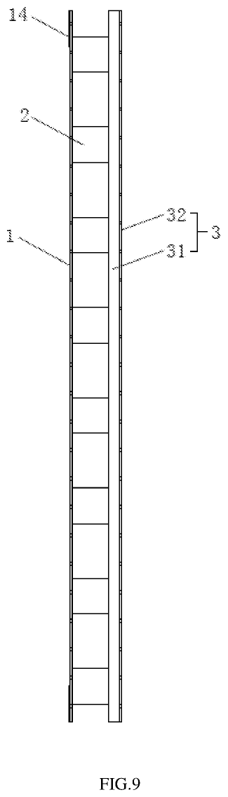

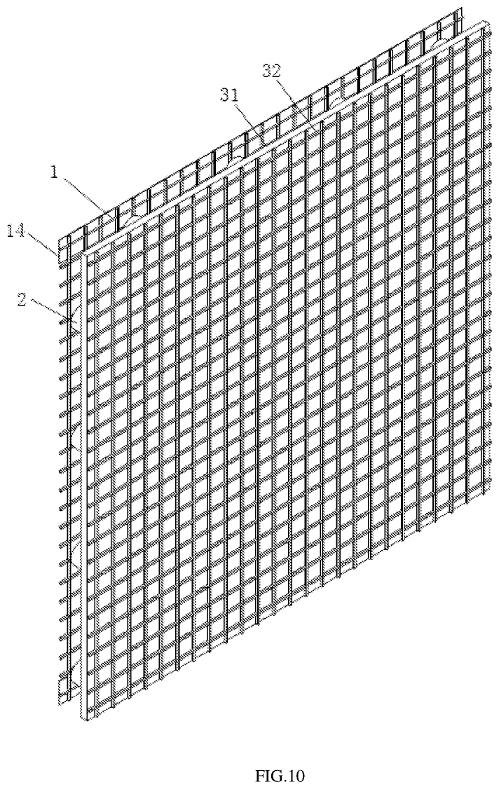

Referring to FIG. 9 and FIG. 10, this embodiment differs from Embodiment 3 in that, the surface layer 3 includes a second waterproof layer 31 and a second mesh layer 32. In one embodiment, the second waterproof layer 31 is a non-woven cloth, the second mesh layer 32 is a glass fibre mesh cloth, and the second waterproof layer 31 and the second mesh layer 32 are adhesively fixed.

This embodiment can be applied to a building envelope, for example, the outer surface of a breathable paper provided on the outer surface of a building. By adhesively fixing the first mesh layer onto the outer surface of a breathable paper 12, a rainproof curtain wall can be formed, serving the functions of drainage, ventilation, and moisture permeability. Providing the second mesh layer 32 facilitates a wet operation and construction.

### Embodiment 5

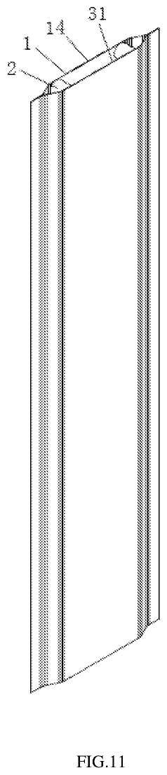

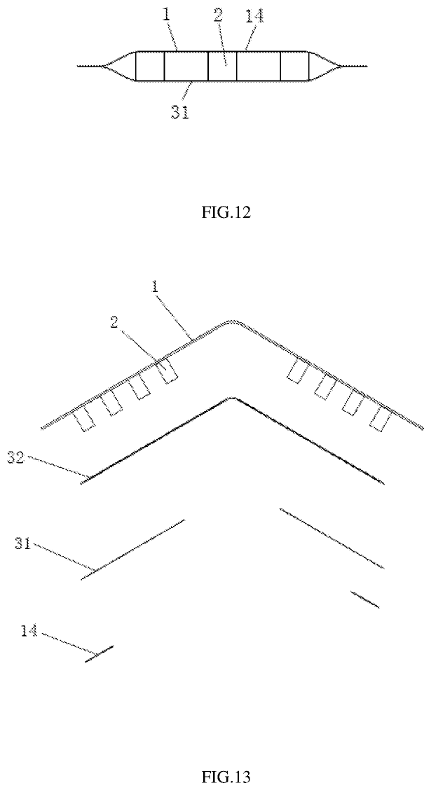

Referring to FIG. 11 and FIG. 12, this embodiment differs from Embodiment 3 in that, the inner lining layer 1 is a first waterproof layer, which can be made of EVA, PE, PVC, ECB, PU, TPE, or glass fibre. In one embodiment, the first waterproof layer is a non-woven cloth. In other embodiments, the first waterproof layer can be one or more selected from the group consisting of a plastic film, a plastic woven cloth, or a glass fibre cloth. The surface layer 3 is a second waterproof layer 31, which can be a non-woven cloth.

This embodiment can be applied to a building envelope, for example, the outer surface of a breathable paper provided on the outer surface of a building. By adhesively fixing the first waterproof layer onto the outer surface of a breathable paper 12, a rainproof curtain wall can be formed, serving the functions of waterproofness, drainage, ventilation, and moisture permeability. In this embodiment, the rainproof curtain wall is made into a long strip shape, and a plurality of rainproof curtain walls are adhesively fixed onto the outer surface of the breathable paper 12 transversely at an interval. Adopting a long strip shape can save materials, reduce the production cost, and facilitate mounting a flitch plate on the outer surface of the second waterproof layer 31 or the like.

### Embodiment 6

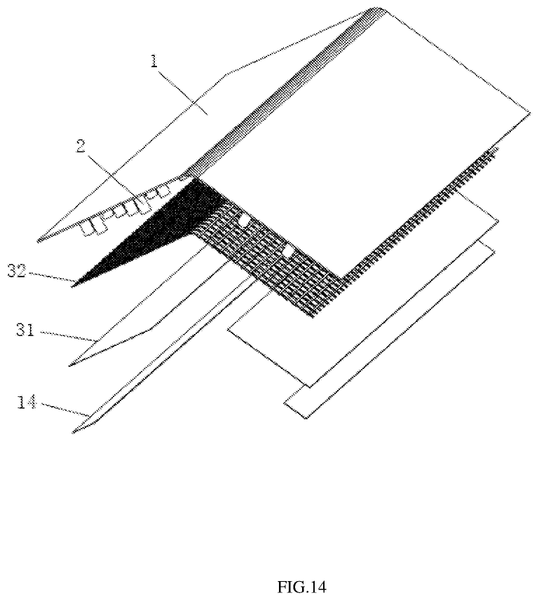

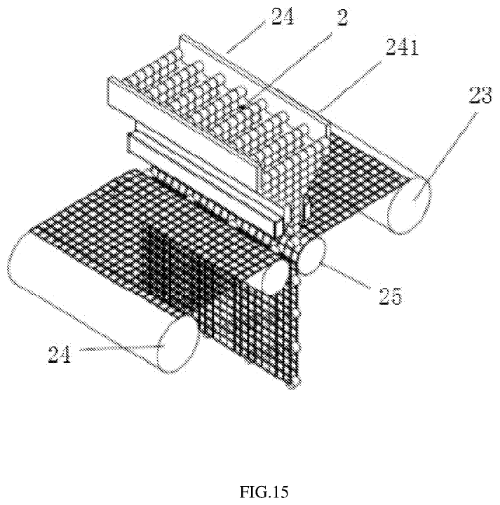

Referring to FIG. 13 and FIG. 14, this embodiment differs from Embodiment 1 in that, the inner lining layer 1 is a first waterproof layer, which can be made of EVA, PE, PVC, ECB, PU, TPE or glass fibre. In this embodiment, the first waterproof layer is made of TPE. The surface layer 3 includes a second waterproof layer 31 and a second mesh layer 32. In this embodiment, the second waterproof layer 31 is a non-woven cloth, and the second mesh layer 32 is a glass fibre mesh cloth. One side of the second mesh layer 32 is fixed with the resilient bump 2, and the other side of the second mesh layer 32 is fixed with one side of the second waterproof layer 31.

This embodiment can be applied to a ventilation structure, for example, the roof of a building. For example, an air outlet is provided at the ridge of the roof top, and a first air inlet and a second air inlet are respectively provided in the eaves on both sides of the roof. Rainproof curtain walls are respectively provided outside the air outlet, the first air inlet, and the second air inlet, and the other side of the second waterproof layer 31 is adhesively fixed outside the air outlet, the first air inlet and the second air inlet, so as to form a ridge ventilation structure, which can achieve the ventilation in the triangle area of the roof to ensure a good air circulation. In this embodiment, the other side of the second waterproof layer 31 is provided with a self adhesive tape 14.

### Embodiment 7

Referring to FIG. 7 and FIG. 8, this embodiment differs from Embodiment 1 in that, the inner lining layer 1 is a first mesh layer, which can be made of EVA, PE, PVC, ECB, PU, TPE or glass fibre. In this embodiment, the first mesh layer is a glass fibre mesh cloth, and the surface layer 3 is a second mesh layer 32, which is a glass fibre mesh cloth.

This embodiment can be applied to a building envelope, for example, at least one of a wall body 13, a roof or a floor of a building. Both of the wall body 13 and the roof include an inner panel and an outer panel. A rainproof curtain wall is provided between the inner panel and the outer panel, and/or two adjacent floors of a plurality of floors. The first mesh layer and the second mesh layer 32 are respectively adhesively fixed between corresponding inner panel and outer panel or two adjacent floors of a plurality of floors to form a flexible support structure, which can be used as a cushion layer in place of a wood stud. Since it is flexible, it is easy to transport and install, and at the same time has the functions of drainage and ventilation. In this embodiment, the side of the first mesh layer departing from the resilient bumps 2 is provided with a self adhesive tape 14. Alternatively, the side of the second mesh layer 32 departing from the resilient bumps 2 can be provided with a self adhesive layer 14 for a convenient installation.

Detection:

The products obtained in Embodiments 1-7 have good structural strength, and comply with anti-fire and flame retardant requirements in a building standard. In addition, these products perform well in a waterproof test, showing good ventilation and waterproof performances as required by a waterproof product.

### Embodiment 8

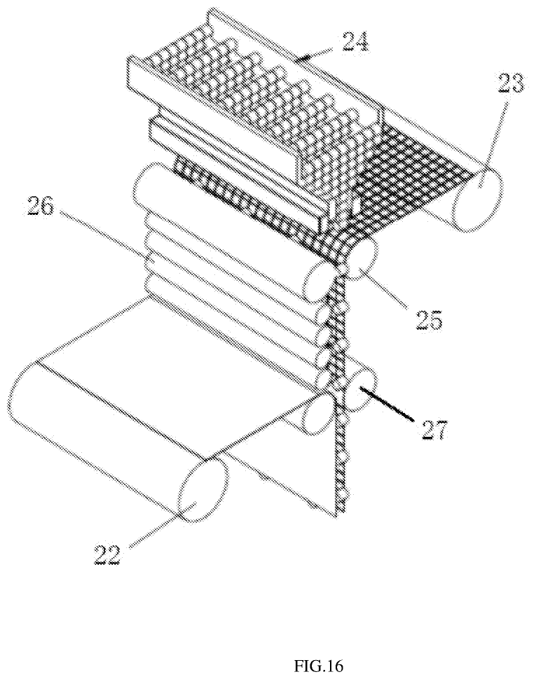

Referring to FIG. 15, an assembly for fabricating a rainproof curtain wall includes a first material rack 22 for providing the inner lining layer 1, a second material rack 23 for providing the surface layer 3, and a feeder 24 for providing the resilient bump 2, in which the feeder 24 is located between the first material rack 22 and the second material rack 23. In one embodiment, the feeder 24 includes a feeding bin 241 and a hot compression roller 25 provided at a discharge port of the feeding bin 241. The materials from the first material rack 22 and the second material rack 23 are fed to the hot compression roller 25. In one particular embodiment, when the inner lining layer is a first mesh layer and the surface layer is a second mesh layer 32 (that is, the rainproof curtain walls in Embodiment 3 and Embodiment 7), the inner lining layer 1 provided by the first material rack 22 and the surface layer 3 provided by the second material rack 23 are fed to the hot compression roller, and the resilient bumps 2 provided by the feeding bin 241 fall into the hot compression roller 25, where the hot compression roller 25 heats the two ends of the resilient bumps 2 and fixes the resilient bumps 2 between the inner lining layer 1 and the surface layer 3 by pressing, so as to form a complete rainproof curtain wall. In this embodiment, the first material rack 22, the second material rack 23 and the hot compression roller 25 are arranged side by side along the horizontal direction, and the feeding bin 241 is disposed right over the hot compression roller 25.

### Embodiment 9

Referring to FIG. 16, a method for fabricating a rainproof curtain wall is provided. This embodiment differs from Embodiment 8 in that, the feeder 24 includes a feeding bin 241, a hot compression roller 25 provided at the discharge port of the feeding bin 241, and a compression roller 27 provided under the hot compression roller 25, with a heating tube 26 being provided between the hot compression roller 25 and the compression roller 27. The material from the first material rack 22 is fed to the compression roller 27, and the material from the second material rack 23 is sequentially fed to the hot compression roller 25 and the compression roller 27. Based on actual needs, when the first lining layer 1 is a waterproof moisture-permeable layer and the surface layer is a second mesh layer 23, the surface layer 3 provided by the second material rack 23 is fed to the hot compression roller 25, and the resilient bump 2 provided by the feeding bin 231 falls onto the hot compression roller 25, so that the hot compression roller 25 heats one end of the resilient bump 2 and fixes it onto the surface layer 3 by pressing. Meanwhile, the surface layer fixed with the resilient bump 2 is fed to compression roller 27, during which the other end of the resilient bumps 2 are heated by the heating tube 26, so that the other ends of the resilient bumps 2 become sticky and fixed onto the inner lining layer 1 fed to the compression roller 27 under the compression of the compression roller 27 when surface layer 3 is fed to the compression roller 27. Then, the fabrication of the rainproof curtain wall is finished. In this embodiment, the second material rack 23 and the hot compression roller 25 are disposed side by side along the horizontal direction, the feeding bin 241 is disposed right over the hot compression roller 25, the compression roller 27 is disposed right under the hot compression roller 25, and the first material rack 22 and the compression roller 27 are disposed side by side along the horizontal direction.

The embodiments provided above are some of the preferred embodiments of the present application, not intended to limit the scope of the present application thereto. Therefore, equivalent changes made to the structure, shape, and principle of the present application should fall within the scope of the present application.

### REFERENCE SIGN LISTING

1. inner lining layer
2. resilient bump
3. surface layer
31. the second waterproof layer
32. the second mesh layer
12. breathable paper
13. wall body
14. self adhesive tape
22. the first material rack
23. the second material rack
24. feeder
25. hot compression roller
26. heating tube
27. compression roller

1. A rainproof curtain wall comprising an inner lining layer, a plurality of resilient bumps arrayed on a side of the inner lining layer, and a surface layer provided on a side of the resilient bumps departing from the inner lining layer.

2. The rainproof curtain wall of claim 1, wherein the first inner lining layer comprises a first mesh layer, a waterproof moisture-permeable layer or a first waterproof layer, and the surface layer comprises a second waterproof layer and/or a second mesh layer.

3. The rainproof curtain wall of claim 2, wherein the material of the resilient bumps is selected from the group consisting of EVA, PP, PE, PU, foamed EVA, foamed PP, foamed PE, or foamed PU, the material of the waterproof moisture-permeable layer is selected from the group consisting of EVA, PE, PVC, ECB, PU, PP, or TPE, the material of the first mesh layer and the first waterproof layer is selected from the group consisting of EVA, PE, PVC, ECB, PU, TPE, or glass fibre, and the material of the second waterproof layer and the second mesh layer is selected from the group consisting of EVA, PE, PVC, ECB, PU, TPE or fibre glass.

4. The rainproof curtain wall of claim 3, wherein the resilient bumps have a height of 1-20 mm; and the resilient bumps are adhesively fixed with the inner lining layer and the surface layer by hot-melting connection.

5. An assembly used for fabricating the rainproof curtain wall of claim 4, comprising a first material rack for providing the inner lining layer, a second material rack for providing the surface layer, and a feeder located between the first material rack and the second material rack for providing the resilient bumps;
wherein the feeder includes a feeding bin and a hot compression roller provided at a discharge port of the feeding bin; or
wherein the feeder includes a feeding bin, a hot compression roller provided at a discharge port of the feeding bin, and a compression roller provided under the hot compression roller, with a heating tube provided between the hot compression roller and the compression roller.

6. A waterproof moisture-permeable roll material comprising the rainproof curtain wall of claim 2, wherein the inner lining layer comprises a waterproof moisture-permeable layer, the surface layer comprises a second waterproof layer, or the surface layer comprises a second waterproof layer and a second mesh layer.
